(19) United States
(12) Patent Application Publication
(10) Pub. No.: US 2014/0142925 A1
(43) Pub. Date: May 22, 2014

(54) SELF-ORGANIZING UNIT RECOGNITION FOR SPEECH AND OTHER DATA SERIES

(71) Applicant: RAYTHEON BBN TECHNOLOGIES, Cambridge, MA (US)

(72) Inventors: Herbert Gish, Newton, MA (US); Man-Hung Siu, Lexington, MA (US); Stephen Alan Lowe, Sudbury, MA (US)

(73) Assignee: Raytheon BBN Technologies, Cambridge, MA (US)

(21) Appl. No.: 13/679,229

(22) Filed: Nov. 16, 2012

(51) Int. Cl. G06F 17/27

(52) U.S. Cl. CPC G06F 17/2735
USPC 704/10

(57) ABSTRACT

An approach automated processing for audio or other data series or signals, which is applicable where little or no transcribed training data is available, makes uses identification of self-organizing units (SOUs) in conjunction with automated creation of, or augmentation of an existing dictionary, with “pseudo-words” or tokens represented in terms of the SOUs. In some examples, the dictionary is iteratively updated (e.g., augmented) during training, optionally with updating of models of the SOUs during the iteration.

### STATEMENT AS TO FEDERALLY SPONSORED RESEARCH

This invention was made with government support under H98230-06-C-0482/0000. The government has certain rights in the invention.

### BACKGROUND

This invention relates to automated recognition events in a data series using self-organizing units, and in particular to recognition of events in a speech signal.

Many speech applications require large amounts of transcribed audio for supervised training of the speech recognition models. For some domains, transcribed audio can be difficult to come by. Different approaches for speech recognition training have recently been proposed for using various amounts of limited resources, such as converting models from related languages, or bootstrapping with a small amount of transcribed data.

Many approaches for the analysis of speech signals use an automated transcription (i.e., the word sequence output of an automated speech recognizer, also referred to as a speech-to-text system) as an intermediate representation of a speech signal. The automated transcription is then used for further processing. For example, topic identifications (TID) system for speech signals can be based on the characteristics of the words in the automated transcription. Note that some approaches do not require that the words in the transcripts are meaningful—what is important is that the word sequences in the automated transcriptions capture the information that is useful for further processing, for example, by statistically capturing information indicative of the topic of a conversation.

One general approach to zero resource (i.e., no transcriptions) speech recognition is described in A. Park and J. Glass, “Towards unsupervised pattern discovery in speech,” Proc. IEEE Workshop on Automatic Speech Recognition and Understanding, San Juan, Puerto Rico, 2005; A. Park, T. J. Hazen, and J. Glass, “Automatic processing of audio lectures for information retrieval: Vocabulary selection and language modeling,” Proc. ICASSP, Philadelphia, 2005, pp. 497-450; and Y. Zhang and J. Glass, “Unsupervised spoken keyword spotting via segmental DTW on Gaussian posteriorgrams,” Proc. ASRU, 2009, pp. 398-403. This approach generally employs a dynamic time warping (DTW) matching of features to find common occurrences of patterns. These DTW methods rely on individual string patterns results without necessarily capturing natural variations Is string patterns that are generated by the same underlying event. For example, DTW-based speech recognizers are highly speaker dependent.

Another approach to self-organizing speech recognition for information extraction is described in U.S. Pat. No. 7,389,233, issued to Gish on Jun. 17, 2008. Related approaches are described in H. Gish, et al, “Unsupervised training of an HMM-based speech recognition system for topic classification,” Interspeech 2009; in M. Siu et al., “Improved topic classification and keyword discovery using an HMM based speech recognizer trained without supervision”, Interspeech 2010; and in M. Siu et al. “Unsupervised Audio Patterns Discovery using HMM-based Self-Organized Units”, Interspeech 2011. This prior patent and related papers are incorporated herein by reference. In some of these approaches, an iterative unsupervised HMM training strategy where the HMM was used to transcribe the audio into a sequence of self-organized speech units (SOUs) using only untranscribed speech for training. One application of the resulting unit sequences is for topic identification (TID). One significant advantage of completely unsupervised training is a reduction of mismatch between training and test data, for example, because the untranscribed test data can, if needed, be added for acoustic training

### SUMMARY

In one aspect, in general, an approach automated processing for audio or other data series or signals where little or no transcribed training data is available makes uses identification of self-organizing units (SOUs) in conjunction with automated creation of, or augmentation of an existing dictionary, with “pseudo-words” or tokens represented in terms of the SOUs. In some examples, the dictionary is iteratively updated (i.e., augmented) during training, optionally with updating of models of the SOUs during the iteration.

In one aspect, in general, an approach to automatically forming a dictionary of tokens from a signal makes use of an iterative approach in which successive dictionaries are determined through successive processing of the signal, and in at least some iterations, a signal model is determined from the signal for the tokens of the dictionary determined at that iteration. In some examples, the approach is applied to a speech signal, for example, to automatically form a dictionary of discovered words or commonly repeated phonetic patterns in a language or vocabulary domain for which an adequate dictionary is not available. Such a dictionary can be applied to speech processing tasks, for example, for automated topic or speaker classification.

A computer-implemented method is used to form a dictionary representing events in a first signal (120) in a series of iterations. In each iteration (N) of a series of iterations (N≧1), a current dictionary (D_{N}) that includes a plurality of tokens determined prior to the iteration us used to determine a modified the dictionary (D_{N+1}) that includes tokens not present in the current dictionary. Each iteration includes the following steps. First, a current token series (T_{N}) representing the first signal (120) in terms of tokens of the current dictionary is determined by using a computer-implemented signal analysis module (206) to process the first signal using a current signal model (M_{N}) characterizing signal characteristics of tokens in the current dictionary. Then the modified dictionary (D_{N+1}) is determined by identifying one or more events represented in the current token series (T_{N}) and one or more tokens are added to the current dictionary to form the modified dictionary. Each added token represents one of the events identified in the current token series. In at least some iterations (e.g., other than a final iteration of the series of iterations) a modified token series (\tilde{T}_{N+1}) in terms of tokens of the modified dictionary (D_{N+1}) is determined using to the current token series (T_{N}), and a computer-implemented model training module (216) is used to process the first signal (120) according to the modified token series (\tilde{T}_{N+1}) to determine a modified signal model (M_{N+1}) characterizing signal characteristics of the tokens of the modified dictionary (D_{N+1}). The modified dictionary is then used as the current dictionary and the modified signal model is used as the current signal model in a subsequent iteration of the series of iterations.

Aspects can include one or any combination of more than one of the following features.

Identifying the one or more events represented in the token series includes identifying repeated token sequences in the token series. Identifying repeated events can include counting occurrences of token n-grams in the current token series, and selecting one or more of the token n-grams according to their counts of occurrences as the one or more events.

The modified dictionary determined at an iteration includes a representation of each added token in terms of units used to represent tokens in the current dictionary.

The modified signal model includes data representing a Hidden Markov Model (HMM) characterizing the tokens of the modified dictionary. The data representing the HMM can include data characterizing a plurality of units used to represent the tokens of the modified dictionary.

Prior to the series of iterations a dictionary (D₁) is initialized by grouping segments of the first signal into groups according to similarity of signal characteristics, each group of segments being associated with a label of the group, each token of the dictionary (D₁) corresponding to one group. An initial token series (T₀) is also determined according to the labels associated with successive segments of the data signal.

Prior to the series of iterations the model training module (214) is used to process the data signal according to the initial token series (T₀) to determine an initial signal model (M₁) characterizing signal characteristics of the tokens of the initialized dictionary (D₁).

Prior to the series of iterations, a dictionary (D₁) is initialized to include tokens each representing a predetermined signal unit, and providing an initial signal model (M₁) trained on a second signal other than the first signal. The first data signal can represent a speech signal and the predetermined signal units comprise word units. The initial model can be trained using a transcription of at least some of the second signal. The predetermined signal units can comprise subword units. At least some of the subword units can be phoneme units. The initial model can be trained on a transcribed speech signal other than the first signal. The subword units can be associated with a language other than that represented in the first signal.

The first data signal represents a speech signal, and a word transcription of at least some of the first data signal is accepted in which each word of the transcription has a spelling in a pre-specified alphabet. A token series of the at least some of the first data signal and the word transcription are used to form a mapping from spellings to token sequences. The mapping is used to add tokens to a dictionary, including accepting a word to add to the dictionary and mapping a spelling of the word to a token sequence for the word. The spellings can be orthographic spellings. The spellings can alternatively be phonetic spellings, and the pre-specified alphabet is a phonetic alphabet.

After the series of iterations, a third signal is processed to determine a token series (T) representing the third signal in terms of tokens of a modified dictionary (D_{N+1}) determined in the series of iterations. This processing includes using the signal analysis module (202) to process the third signal using a modified signal model (M_{N+1}) characterizing signal characteristics of tokens in the modified dictionary (D_{N+1}). The third signal is classified according to statistical characteristics the determined token series. The classifying can be according to a topic, or a speaker.

At least some of the tokens of a modified dictionary can correspond to vocabulary items. At least some of the tokens of a modified dictionary can correspond to prosodic patterns.

The first signal can be a video signal, or a biological signal (e.g., an ECG signal).

Advantages of one or more aspects include being able to apply vocabulary-based speech analysis approaches to domains in which a dictionary of vocabulary items is not available. For example, a suitable dictionary may not be available because the language is not known or a dictionary in a known language is not available, or because the signal includes vocabulary items that are particular to a domain, for example, relating to technical terms, proper names, etc. that are not available prior to processing.

The approaches introduced above can be used in applications where a time series (e.g., speech and video) has events that can be characterized by similar repeated patterns. For example, in speech, there is repeated occurrence of certain words and in video we can have repeated patterns such as a moving vehicle. The detection of such repeated patterns can be employed in the characterization of the time series, e.g., the word occurrences are indicative of a particular topic being spoken about.

Other features and advantages of the invention are apparent from the following description, and from the claims.

### DESCRIPTION OF DRAWINGS

FIG. 1 is a block diagram that illustrates an initialization procedure;

FIG. 2 is a block diagram that illustrates one iteration of an iterative procedure; and

FIG. 3 is a block diagram that illustrates application of the iteratively formed dictionary and models.

FIG. 4 is a block diagram that illustrates an alternative initialization procedure.

### DESCRIPTION

In a first implementation, an approach to speech processing is directed to a situation in which a speech corpus is available, but that corpus does not have a corresponding transcription or dictionary available. For example, the language being spoken may not be known, or if known, a dictionary or other enumeration of linguistic units may not be available for that language. Nevertheless, the approach infers structure (e.g., linguistic units) that represents or are analogous to words from the speech itself. In the discussion below, these units are referred to as “pseudo-words” or “tokens” without intending to require that the units are truly related to words in the language being spoken. Presence of these tokens in a signal is treated as events, which can be used for further processing of the signal.

In some examples, this speech corpus is referred to as a “training” corpus in that a speech processing system is configured (i.e., trained using statistical techniques) based on this corpus, and then the configured system is used to process yet other speech, which is referred to as a “test” corpus. Note that although the language being spoken and transcription is not available, other information about the training corpus may be known. For example, topic labels may be associated with parts of the training corpus, and the system may be configured to distinguish topics in the test corpus based on the inferred structure and its correlation with topics in the training corpus. In other examples, the “training” corpus is itself the target of analysis, for example, based on clustering or other grouping of parts of the corpus according to occurrence of the inferred tokens.

This implementation involves an initialization phase in which a set of underlying self-organizing units are identified and then the training corpus is transcribed (at least partially) according to those units. An iterative phase is then conducted in which in each iteration (a) a dictionary is updated with tokens represented in terms of the units, and (b) models of the signal realization of the units are updated and optionally a sequence model (e.g., “language model”) for the tokens of the dictionary are updated based on the current dictionary.

Without intending limit the meaning or scope of the terms being used, the units (i.e., self-organizing units) can be considered analogous to phonetic units, and the tokens of the dictionary considered analogous to words. However, the terms “units” and “tokens” are generally used below to reinforce the fact that there may be no linguistic basis for the units and tokens. Furthermore, in some examples, the training corpus may be partitioned, for example, into separate utterances. However, this is not required, and the input, whether partitioned or not, is generally referred to as a “signal”. In the discussion below, the term “dictionary” is used broadly to include a data structure that encodes a mapping from tokens (e.g., pseudo-words) to structure represented in terms of the underlying units. An example of such a structure, without being limited to this form, is an enumeration of the tokens in the dictionary, and for each token, a sequential list of units that represent the realization of that token in terms of the units, analogous to a phonetic spelling if the units were phonemes and the tokens words. Other forms of dictionary are within the scope of the discussion below, including dictionaries that for each token can represent multiple alternative unit sequences (e.g., as alternatives, as a graphs, and/or generated according to a probabilistic process).

This implementation, as well as a number of alternative implementations discussed below, makes use of an initialization phase which results in a full or partial transcription of the training signal in terms of a set of units.

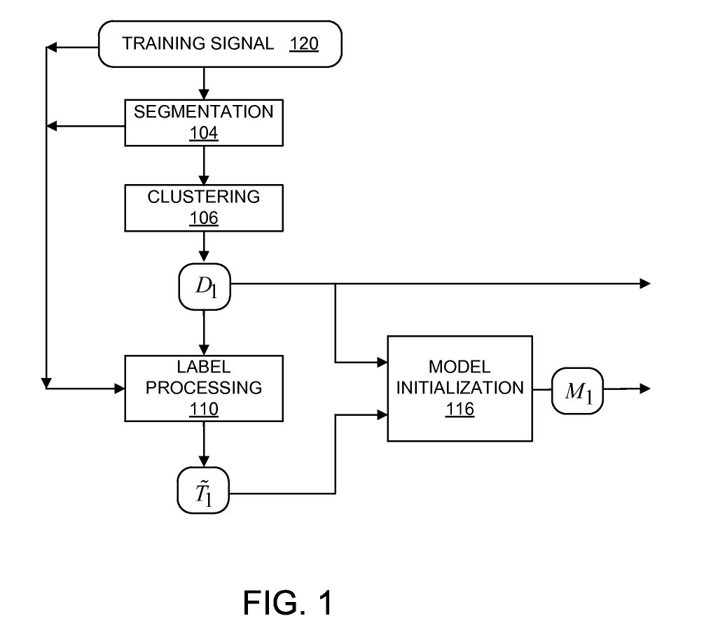

Referring to FIG. 1, in one implementation of the initialization procedure, the training signal 120 is first segmented in a segmenter 104 into variable time duration segments. In some implementations, this segmentation is based on its spectral discontinuities which are learned without supervision from the audio signal, but is should be recognized that other approaches to this initial segmentation (also referred to as “tokenization”) may be used. A distance measure is defined on these segments such that acoustically similar segments have lower distance between then than acoustically dissimilar segments. This distance measure is then used to cluster the segments in to a number of segment clusters. The number of clusters may be predetermined, or alternatively, the number of clusters may be determined by the data itself, for example, according to a stopping rule in an agglomerative clustering approach. As a specific example, of a distance measure, each segment is represented by a polynomial (e.g., quadratic) trajectory in the cepstral space, and the distance between a pair of segments is determined by a distance between their polynomial trajectories. Another approach to clustering is based on similarity of covariance matrices for the segments as described in U.S. Pat. No. 7,389,233. Using this approach, each segment for the training signal has a unique label for the cluster into which it is grouped. Each cluster corresponds to a different one of the units upon which further processing is described below. Note that the training signal can at this point be transcribed according to the cluster/unit labels. In some implementations, the units are identified by indexes 1, . . . , m, or by corresponding labels P1, . . . , Pm, where m is the number of clusters identified in the initialization procedure.

Generally, initialization is continued by using the cluster labels to form statistical models for each of the clusters, for example, using a segmental Gaussian model for each segment, and using this as to initialize a mixture of segmental Gaussian models that is iteratively improved using an Estimate-Maximize procedure. The result is that each segment is associated with probability distribution of which cluster it is associated with, as well as a cluster with the highest probability. These highest probability labels for the segments are used as the initializing transcription of the training signal.

An initial dictionary, referred to as D₁, is formed such that each token in the dictionary represents a different signal unit determined in the clustering procedure above. In some implementations, the dictionary has a set of tokens {W1, W2, . . . } where each token has a corresponding representation as a sequence of units. This initial dictionary include m words, such that the i^{th} word Wi is represented as the sequence of a single unit Wi→[Pi]. The initial transcription of the training signal in terms of the tokens Wi is referred to as \tilde{T}₁. The transcription comprises a sequence of tokens Wi from the initial dictionary D₁, which corresponds directly to the sequence of labels Pi determined from the segment labels.

A final stage of initialization makes use of the initial transcription \tilde{T}₁ to form and initial model M₁ for the units. Specifically, a conventional approach to training a Hidden Markov Model (HMM) makes use of the transcription and the training signal to estimate HMM models for the units. In general this initial training is itself iterative (e.g., using an iterative Baum-Welch approach). The model M₁ also optionally includes a statistical sequence model (e.g., language model) for the tokens of the dictionary as represented in the initial transcription \tilde{T}₁, for example, represented as an n-gram (Markov) model. Although not explicitly relied upon, a result for this stage is a new segmentation of the training signal, which is not necessarily the same as the original segmentation from which the clustering was performed.

Note that some prior approaches make use of these trained HMM models to convert training and test signals into sequences of segment labels. Then, subsequent processing makes use of characteristics of these label sequences, for example, based on identification of repeated subsequences.

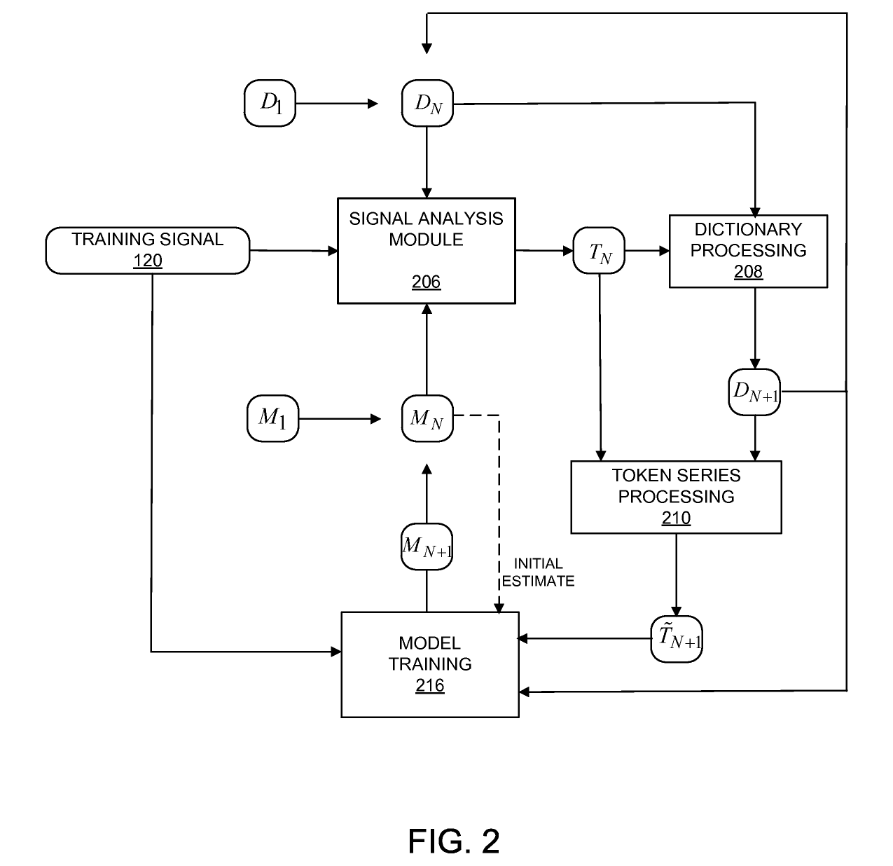

Referring to FIG. 2, in the present approach, an iterative procedure is used to update the dictionary and well as the models represent the realizations of the tokens in the dictionary and the sequencing of those tokens. The process illustrated in FIG. 2 is formed for iterations indexed by N starting at N=1.

At the N^{th} iteration, a signal analysis module 206 processes (recognize) the training signal 120 according to the current dictionary D_{N} and the current model M_{N}. Note that optionally, the training signal 120 used in the procedure shown in FIG. 2 may be different than the training signal 120 shown in the initialization procedure shown in FIG. 1. For the first (N=1) iteration, the current dictionary is D₁ and the current model is M₁ are determined in the initialization procedure illustrated in FIG. 1, The result is an output transcription T_{N} (recognition output) in terms of the tokens of D_{N}. On the first (N=1) iteration, the result is essentially a transcription T₁ of the training signal in terms of the cluster/unit labels, and will generally the same or very similar to the transcription \tilde{T}₁ with which the last stage of initialization (i.e., HMM training) is initialized.

A next step of the N^{th} iteration involves using the transcription Tₙ to process the current dictionary D_{N} in the dictionary processing element 208 to form the incrementally changed (e.g., augmented) dictionary D_{N+1}. A number of specific procedures for performing this incremental change are discussed below. As a representative procedure, a single new token is added to represent a concatenation of two existing tokens in the dictionary. The two tokens to concatenate are chosen according to the statistics of the joint occurrence in the transcription T_{N}. Based on the new dictionary, the transcription T_{N} is processed by a token series processing element 210 to use the newly added tokens in the dictionary D_{N+1}. As an example, in the first iteration, a sequence of tokens Wi, Wj may be identified in the transcription T_{N}. In this example for the first iteration, Wi→[Pi] and Wj→[Pj]. An (m+1)^{st} word is added to the dictionary as W(m+1)→[Pi,Pj]. In this example, the token series processing element 210 replaces each occurrence of Wi, Wj in T_{N} with W(m+1) to form T_{N+1}. More generally at subsequent iterations, the new token added to the dictionary is formed by concatenation of multiple-unit subsequences.

A next step of the N^{th} iteration is to improve the models M_{N} to form new models M_{N+1}. For example, a conventional HMM training module 216 optionally uses the models M_{N} as an initial estimate and the new transcription T_{N+1} and dictionary D_{N+1} to determine the new models M_{N+1}. This model training module is similar to the model initialization module 116, with the exception that the HMM training module 216 optionally starts with the current models.

This completes the N^{th} iteration, and the (N+1)^{st} iteration begins. Assuming that a single token is added to the dictionary at each iteration, and there are initially m units and therefore tokens in D₁, there are now m+N tokens in dictionary D_{N}.

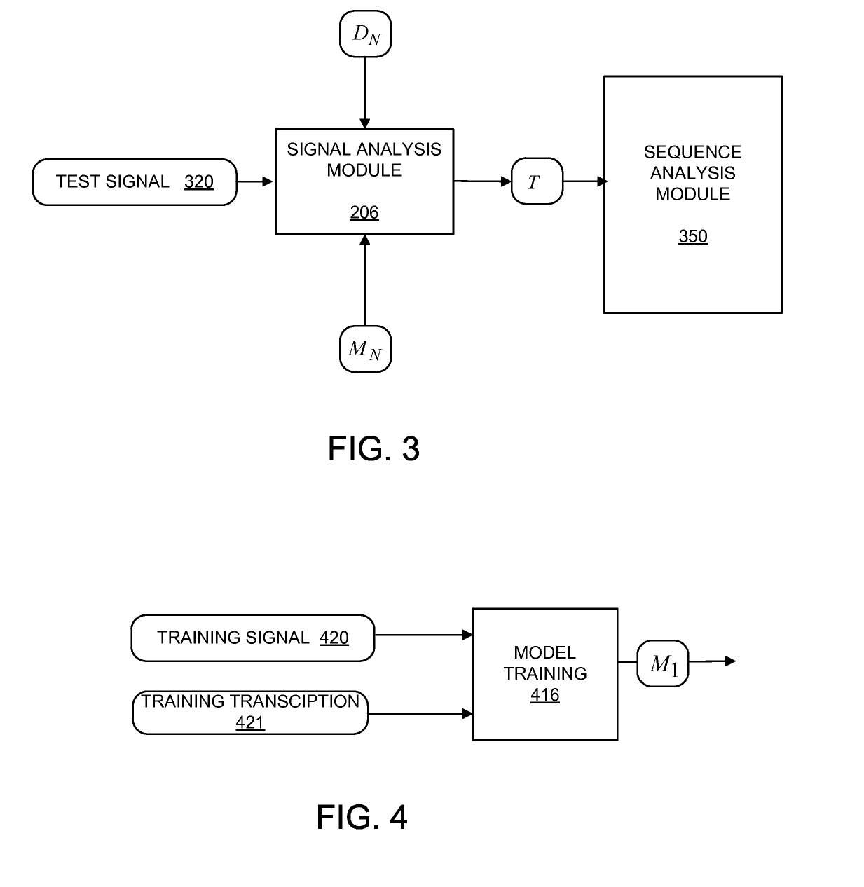

Referring to FIG. 3, in some examples, the final dictionary D_{N} and models M_{N} are used to process a test signals 320 using the sequence analysis module 206, which was used in the training iterations, to form a corresponding token sequence T, which are used for various applications represented as a sequence analysis module 350. For example, the analysis module can cluster of parts of the test signal or classify test signals by topic based on the token sequence T. Note that the final dictionary and models do not have to be applied to exactly the same signal analysis module as in training. For example, rather than full transcription of the test signal, various event detection (e.g., word spotting) approaches can be used to process the test signal.

Note that addition of only a single new token to the dictionary in each iteration is not required. Rather, a multiple new tokens can be added at each iteration. Furthermore, the new tokens can represent sequences of more than two tokens in the recognized sequence. For example, all n-grams with frequency in the recognized sequence that is significantly higher than predicted by the sequence model can be added to the dictionary. In some examples, tokens may be removed from the dictionary at an iteration, for example, because those tokens are underrepresented in the transcription.

While using frequently occurring strings of tokens as the basis for creating new tokens to be added to the dictionary is an important way of augmenting the dictionary there are other ways of adding tokens to the dictionary. In addition to the frequently occurring tokens less frequently occurring tokens can be added, especially those that may carry significant information. For example, if the training signal consists of audio from conversational speech and each conversation in our training corpus as a “document”, we can, for any string of tokens, create a term frequency, inverse document frequency score for assessing the possible importance of any token string. This measure, usually referred to as a TF-IDF (“term frequency-inverse document frequency”) score is well known in text classification applications, and assigns good scores to strings that are frequently occurring and do not occur in all “documents”. Also, we can find strings of tokens that are effective in discriminating between topics of conversations that we may want to identify. These strings of tokens can be generated by a feature generating application for improving classification performance between topics. For example, a feature generator for Support Vector Machine (SVM) classifiers (see, e.g., “Discriminative Keyword Selection Using Support Vector Machines”, by Campbell and Richardson) for adding such features (strings of pseudo-words) to the dictionary as part of the iterative process.

In the implementation described above, the initialization stage does not require any transcription or any prior models of the units represented in the training signal. In a first alternative implementation, the initial set of units (and thereby the initial dictionary D₁) is chosen to be a predefined set of linguistically based units (e.g., English phonemes). Referring to FIG. 4, the initial models M₁ are then trained on a separate training corpus comprising a training signal 420 and corresponding training transcription, for example, using conventional HMM training approaches using a model training module 416. Note that in such an approach, there can be three different signals: the training signal 420 used to form M₁, the training signal 120 used in the iterative procedure shown in FIG. 2, and then a third signal 320, as shown in FIG. 3. The iterative process described with reference to FIG. 2 then proceeds as described above. Note that it is not necessary that the separate training corpus include speech from the same language as the training corpus 120. For example, use of a similar language (e.g., English phonemes for processing German) may be effective. Other choices for initial dictionary can be used, for example, based on cross-language units (e.g., Worldbet, International Phonetic Alphabet, etc.). Furthermore, non-linguistic (acoustically based) units training identified and trained on a separate corpus can also be used (e.g., fenones), and larger linguistic units (e.g., syllables) can also be used in this approach.

In a second alternative implementation, the training signal 120 is not assumed to be completely untranscribed. In a first variant of this approach, a very small about of transcribed signal (e.g., in the order of 15 minutes of audio) is available, while the rest is untranscribed. We assume that there is inadequate data to train phonetic models as is done in the first alternative implementation described above. In this alternative, the initialization procedure that is described with reference to FIG. 1 is performed, yielding an automated transcription T₁ of all the training signal in terms of the self-organized units of the initial dictionary D₁. The very small amount of transcription of the limited amount of the training signal is assumed to be in an alphabet (e.g., roman letters), generally native to the language being spoken. This limited amount of transcription is used to build a mapper from sequences in the transcription alphabet to sequences of tokens/units in the automated transcription. One approach to building such a mapper is using multigram mapping, for example, as described in Sabine Deligne, Francois Yvon, and Frederic Bimbot, “Variable-length sequence matching for phonetic transcription using joint multigrams,” Proc. EUROSPEECH, pp. 2243-2246, 1995. This mapping is then used to convert words, which may or may not be present in the small amount of transcription, into dictionary tokens represented as sequences of the self-organizing units. Having augmented the initial dictionary D₁ with this procedure, the iterative procedure described with reference to FIG. 2 proceeds as described above.

In a second variant of the second alternative approach, more transcription than for the first variant is available (e.g., two hours), but the training signal is still largely untranscribed. In this variant, it becomes feasible to train a phone recognizer in the language of interest, assuming that the transcription is accompanied by a dictionary or text-to-sound rules suitable for mapping the words of the transcription to phonemes. Having trained phoneme models, these phoneme models can be used in place of the segmental Gaussian models in the initialization procedure described above, or alternatively, the phone models can be used as described in the first alternative implementation described above.

In a third variant, a significant amount of the training signal is transcribed (e.g., more than 10 hours). A word recognizer is training on the transcribed signal and the dictionary is initialized to include the words of the transcription. Note that this assumes that we have a dictionary of the words of the language in terms of the phonemes of the language. In the dynamic dictionary part of the iterative training we will be able to create compound words from the words that exist in the dictionary as well as pseudo-words as described above. The combination of the two aspects of dictionary updating exploits the structure that exists in the data in a way the conventional training of recognizer does not utilize.

Although described in the context of speech processing, the approaches are clearly not limited to speech. For example, the approaches can be used to form token sequences from a dictionary in other contexts. Other signals that represent a scalar or vector time series in which underlying events have the property that similar events produce similar time series such as repeated words (the events) produce similar audio patterns, it is then possible tokenize/label the time series using the approaches described above. That is, a state-of-the-art Hidden Markov Model recognizer can be employed to recognize the repeated patterns that occur in the data into similar strings of units utilizing tokens (e.g. pseudo-words) in the recognition process. Success of applying these approaches to other signals may depend on having a meaningful way of creating the initial tokenization (i.e., segmentation of the signal).

The use of an SGMM for initialization for other time series is quite feasible if it is possible to automatically segment different events and be able to measure the similarity between events. The segmentation and similarity measure requirements enable us to cluster the event segments for which it is then possible to create an SGMM model.

It should be understood that the form of the dictionary described above is only one example of a representation of tokens (e.g., events) that are present in a data series. In some alternatives, a hierarchical representation is maintained, for example, in the form of a phrase-structured grammar where the dictionary maintains the record of the combinations that were added to the dictionary (e.g., Wn→Wi, Wj, Wk) and a token series can effectively be parsed to reflect now only top-level tokens, but also the constituents that make them up. Various approaches to forming such a grammar could also be used.

Also, as discussed above, each token in the dictionary can be represented as a sequence of units. It should be recognized that the models M_{N} can include context-dependent models as is done with phonemes in phonetic-based speech recognition such that a unit Pj in the context [ . . . , Pi, Pj, Pk, . . . ] has model parameters that depend on Pi and Pk.

The approaches described above may be applied to other audio processing than speech recognition. For example, an audio process, but not speech, is the prosodic behavior of the human voice. Prosody is characterized by variations in acoustic energy and pitch movement and can be segmented based on changes in these quantities. Using the technology disclosed in U.S. Pat. No. 7,389,233 we are able to create an SGMM recognizer for the prosodic patterns of a speaker or group of speakers. Using the technology of this patent disclosure we can use the SGMM recognizer to perform an initialization of the tokenization/labeling, into SOUs of the prosodic data for a speaker or group of speakers and then iteratively train the HMM, using dictionary updating. The result is an HMM prosody recognizer that can tokenize/label prosodic activity in patterns of discovered “pseudo-words”. Such patterns can be of importance in ascertaining a speaker's identity as well as the speaker's emotional state.

The same process employed for prosody can be applied to such audio that is obtained from animals such as whales. A recognizer and SOUs created for whale sounds can be used detect different species and the presence of such species in certain locations. One can use the spectral discontinuity measure for segmentation described in U.S. Pat. No. 7,389,233 and by some other means. After segmentation the process will follow the process we have specified for speech.

Similar to audio, video can be represented as a vector time series. Video is naturally divided into frames and the vector features can either be extracted on a per-frame basis or, more generally from variable frame lengths. The most trivial feature would be the pixels on each frame, but can increase in complexity to the motion vectors used in video coding, or to features extracted from scene analysis etc. Depending on the feature extracted, video SOUs may represent particular video objects, scene movements or other video patterns.

As we have noted above when we have very limited transcribed audio we can create a multi-gram mapping between the letters of a language and SOUs. This mapping can help with the dictionary of the SOU recognizer as well as enable one to find words in audio based on their SOU representations. In addition to learning such a mapping with very limited transcribed audio such a mapping can be learned without supervision, (that is, without any transcribed audio), if there are a large collection of audio that can be tokenized into SOUs, and a large collection of text from similar sources as the audio. Then such a mapping can be learned by minimizing the differences between the sequence statistics of the SOU sequences from the audio, and the sequence statistics of the token sequences after mapping the text sequences into SOUs. The idea of learning a mapping between two non-parallel token corpora based on their frequency statistics has been used in cryptography to break the classical ciphers such as substitution cipher. In our present case, this mapping is generalized to handle mapping of variable length token strings, higher order sequence statistics such as n-grams, as well as fractional count estimates. The problem can also be-formulated as finding two concatenated mappings, one from the text-to-phonemes and one from phonemes-to-SOUs using the same approach. If a pronunciation dictionary is available for the words in the text, in terms of phonemes, we can solve the assignment problem by finding the mapping between phonemes and SOUs.

The approach can also be used to analyze other data series, for example, in analysis of biological signals (e.g., electro-cardiograms, electro-encephalograms, etc.) or analysis and prediction of financial data series. For example, in the electro-cardiogram case, tokens can correspond to sequences of multiple beats. The approach can also be applied to analysis of printed or handwritten text, for example, by forming a data series representing segments along lines of text.

Implementations of the approaches described above can be in software, for example, comprising instructions stored on a tangible computer readable medium having instructions for causing one or more data processing systems to perform the procedures described above. The data processing systems may be distributed in time or space, for example, with the initialization procedure performed on one computer and the iterative training procedure performed on another computer. Implementations can include signal acquisition or storage components, for example, to acquire the training or test signals (e.g., using microphones, data network interfaces, etc.). Implementations can also include output components, for example, to store models, dictionaries, transcriptions, etc. on data storage devices for presentation to a user or for further processing, or to transmit such elements (e.g., over a data communication network) to other data processing systems.

It is to be understood that the foregoing description is intended to illustrate and not to limit the scope of the invention, which is defined by the scope of the appended claims. Other embodiments are within the scope of the following claims.

What is claimed is:

1. A computer-implemented method for forming a dictionary representing events in a first signal, the method comprising, in each iteration of a series of iterations, using a current dictionary that includes a plurality of tokens determined prior to the iteration to determine a modified the dictionary that includes tokens not present in the current dictionary, each iteration including:
determining using a computer and storing a current token series representing the first signal in terms of tokens of the current dictionary, including using a computer-implemented signal analysis module to process the first signal using a current signal model characterizing signal characteristics of tokens in the current dictionary;
determining using the computer and storing the modified dictionary, including identifying one or more events represented in the current token series, and adding one or more tokens in the modified dictionary, each added token representing one of the events identified in the current token series; and
in at least some iterations other than a final iteration of the series of iterations, using the computer, determining a modified token series in terms of tokens of the modified dictionary using to the current token series, using a computer-implemented model training module to process the first signal according to the modified token series to determine a modified signal model characterizing signal characteristics of the tokens of the modified dictionary, and using the modified dictionary as the current dictionary in a subsequent iteration of the series of iterations.

2. The method of claim 1 wherein identifying the one or more events represented in the token series includes identifying repeated token sequences in the token series.

3. The method of claim 2 wherein identifying repeated events includes counting occurrences of token n-grams in the current token series, and selecting one or more of the token n-grams according to their counts of occurrences as the one or more events.

4. The method of claim 1 wherein the modified dictionary determined at an iteration includes a representation of each added token in terms of units used to represent tokens in the current dictionary.

5. The method of claim 1 wherein the modified signal model includes data representing a Hidden Markov Model (HMM) characterizing the tokens of the modified dictionary.

6. The method of claim 5 wherein the data representing the HMM includes data characterizing a plurality of units used to represent the tokens of the modified dictionary.

7. The method of claim 1 further comprising, prior to the series of iterations:
initializing a dictionary including grouping segments of the first signal into groups according to similarity of signal characteristics, each group of segments being associated with a label of the group, each token of the dictionary corresponding to one group; and
determining an initial token series according to the labels associated with successive segments of the data signal.

8. The method of claim 7 further comprising, prior to the series of iterations:
using the model training module to process the data signal according to the initial token series (T₀) to determine an initial signal model characterizing signal characteristics of the tokens of the initialized dictionary (D₁).

9. The method of claim 1 further comprising, prior to the series of iterations, initializing a dictionary to include tokens each representing a predetermined signal unit, and providing an initial signal model trained on a second signal other than the first signal.

10. The method of claim 9 wherein the first data signal represents a speech signal, and wherein the predetermined signal units comprise word units.

11. The method of claim 10 wherein the initial model is trained using a transcription of at least some of the second signal.

12. The method of claim 9 wherein the first signal represents a speech signal, and wherein the predetermined signal units comprise subword units.

13. The method of claim 12 wherein at least some of the subword units are phoneme units.

14. The method of claim 12 wherein the initial model is trained on a transcribed speech signal other than the first signal.

15. The method of claim 12 wherein the subword units are associated with a language other than that represented in the first signal.

16. The method of claim 1 wherein the first data signal represents a speech signal, and the method further comprises:
accepting a word transcription of at least some of the first data signal, each word of the transcription having a spelling in a pre-specified alphabet;
using a token series of the at least some of the first data signal and the word transcription to form a mapping from spellings to token sequences; and
using the mapping to add tokens to a dictionary, including accepting a word to add to the dictionary and mapping a spelling of the word to a token sequence for the word.

17. The method of claim 16 wherein the spellings comprise orthographic spellings.

18. The method of claim 16 wherein the spellings comprise phonetic spellings, and the pre-specified alphabet comprises a phonetic alphabet.

19. The method of claim 1 further comprising, after the series of iterations, processing a third signal, the processing including:
determining a token series representing the third signal in terms of tokens of a modified dictionary determined in the series of iterations, including using the computer-implemented signal analysis module to process the third signal using a modified signal model characterizing signal characteristics of tokens in the modified dictionary; and
classifying the third signal according to statistical characteristics the determined token series.

20. The method of claim 19 wherein classifying the third signal comprises classifying the third signal according to a topic.

21. The method of claim 19 wherein classifying the third signal comprises classifying the third signal according to a speaker.

22. The method of claim 1 wherein the first signal is a speech signal.

23. The method of claim 22 wherein at least some of the tokens of a modified dictionary correspond to vocabulary items.

24. The method of claim 22 wherein at least some of the tokens of a modified dictionary correspond to prosodic patterns.

25. The method of claim 1 wherein the first signal is a video signal.

26. The method of claim 1 wherein the first signal is a biological signal.

27. Software stored on a non-transitory computer-readable medium comprising instructions for causing a computer to form a dictionary representing events in a first signal, the forming comprising, in each iteration of a series of iterations, using a current dictionary that includes a plurality of tokens determined prior to the iteration to determine a modified the dictionary that includes tokens not present in the current dictionary, each iteration including:
determining a current token series representing the first signal in terms of tokens of the current dictionary, including using a signal analysis module to process the first signal using a current signal model characterizing signal characteristics of tokens in the current dictionary;
determining the modified dictionary, including identifying one or more events represented in the current token series, and adding one or more tokens in the modified dictionary, each added token representing one of the events identified in the current token series; and
in at least some iterations other than a final iteration of the series of iterations, determining a modified token series in terms of tokens of the modified dictionary using to the current token series, using a computer-implemented model training module to process the first signal according to the modified token series to determine a modified signal model characterizing signal characteristics of the tokens of the modified dictionary, and using the modified dictionary as the current dictionary in a subsequent iteration of the series of iterations.
